(19) United States
(12) Patent Application Publication
(10) Pub. No.: US 2010/0036936 A1
(43) Pub. Date: Feb. 11, 2010

(54) MODIFICATION OF SOCIAL NETWORKS VIA DESIGN CODES

(75) Inventors: Jason A. Cox, Raleigh, NC (US); Lydia M. Do, Triangle Park, NC (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/187,109

(22) Filed: Aug. 6, 2008

(51) Int. Cl. G06F 15/173

(52) U.S. Cl. 709/223

(57) ABSTRACT

A method including receiving an update to at least one social network map encoded in a design code, modifying the social network map by inserting or deleting social contact data, and regenerating the design code to include the modified social network map.

### BACKGROUND

This invention relates generally to social networks, and particularly to modification of social networks via design codes.

Social networks (or social networking), e.g., via computing devices such as cell phones, personal computers, etc., have become a very popular way of interacting and sharing social contact information among contacts such as friends, family, co-workers, etc. Social network users usually maintain one or more social networks that include various social contact information of their contacts for interaction and other purposes. Typically, users manually add or delete social contact information from their social networks (e.g., via a form on a computing device) when they want to add or delete a contact or otherwise modify their social networks.

### BRIEF SUMMARY

Modification of social networks via design codes is provided. An exemplary method embodiment includes receiving an update to at least one social network map encoded in a design code, modifying the social network map by inserting or deleting social contact data, and regenerating the design code to include the modified social network map.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a system including an exemplary computing device configured to modify social networks via design codes.

FIG. 2 is a block diagram illustrating an exemplary representation of a social network that can be modified via design codes, e.g., by the exemplary computing device of FIG. 1.

FIG. 3 is a flow diagram illustrating an example of a method to modify social networks via design codes, which is executable, for example, on the exemplary computing device of FIG. 1.

The detailed description explains the preferred embodiments of the invention, together with advantages and features, by way of example with reference to the drawings.

### DETAILED DESCRIPTION

According to exemplary embodiments of the invention described herein, modification of social networks via design codes is provided. In accordance with such exemplary embodiments, social network users can efficiently maintain and modify social contact data in one or more social networks using one or more design codes that can be generated, communicated, etc. via a computing device such as a cell phone or personal computer, thereby obtaining a scalable, manageable option for evolving, dynamic social networks.

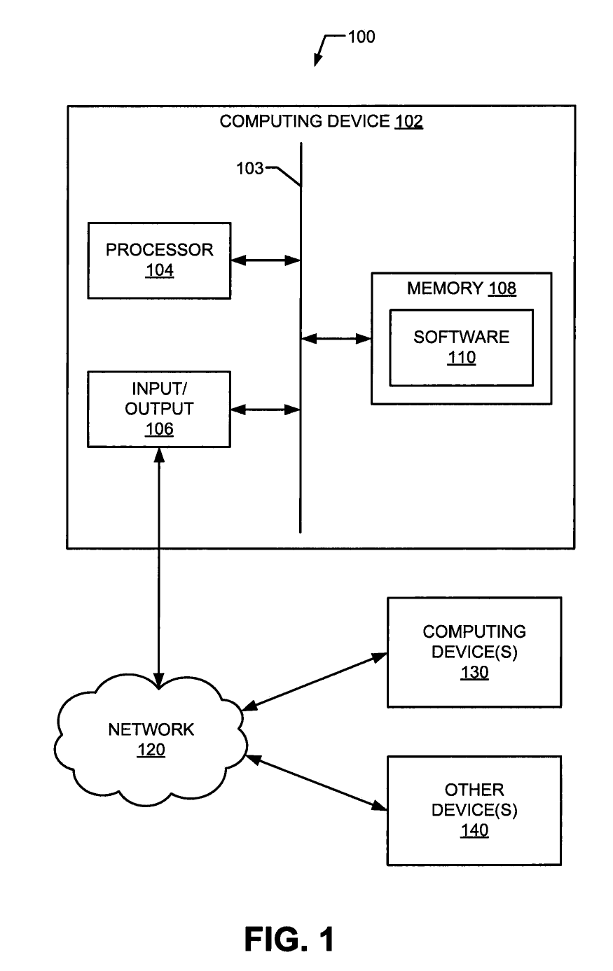

Turning now to the drawings in greater detail, wherein like reference numerals indicate like elements, FIG. 1 illustrates an example of a system 100 including an exemplary computing device 102 configured to modify social networks via design codes. In this regard, computing device 102 may include any device that is capable of receiving, transmitting, and processing data, such as a cell phone, a computer, etc. In addition to computing device 102, exemplary system 100 includes network 120, computing device(s) 130, and other device(s) 140. Network 120 connects computing device 102, computing device(s) 130, and other device(s) 140 and may include one or more wide area networks (WANs) and/or local area networks (LANs) such as the Internet, intranet(s), and/or wireless communications network(s). Computing device(s) 130 may include one or more other computing devices, e.g., that are similar to computing device 102 and which, e.g., may operate as a server device, client device, etc. within system 100. Other device(s) 140 may include one or more other computing devices that provide data storage and/or other computing functions. Computing device 102, computing device(s) 130, and other device(s) 140 are in communication via network 120, e.g., to communicate data between them.

Exemplary computing device 102 may include a processor 104, input/output component(s) 106, and a memory 108, which may be in communication via a bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computing device 102, such as a display, keyboard, modem, network adapter, ports, etc. (not depicted). Memory 108 includes software 110 configured to modify social networks via design codes, which is executable, e.g., by computing device 102 via processor 104. Memory 108 may include other software, data, etc. (not depicted).

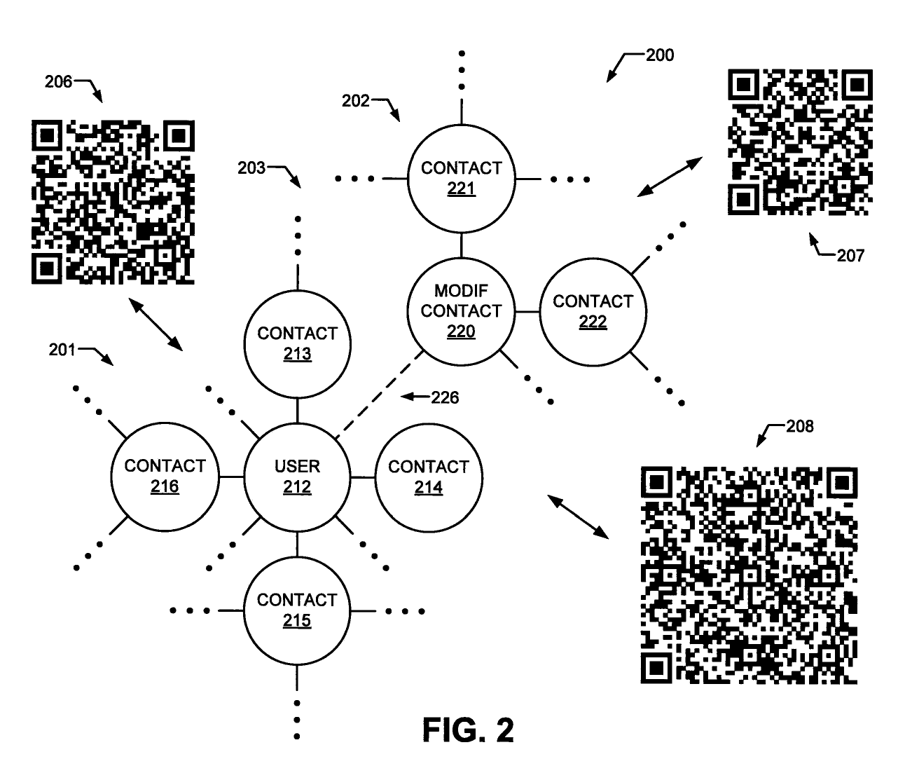

FIG. 2 illustrates an exemplary representation of a social network 200 that can be modified via design codes 206, 207, 208, e.g., by the exemplary computing device 102 of FIG. 1 (e.g., via software 110). Exemplary social network 200 includes representative social network maps 201, 202, 203 and corresponding design codes 206, 207, 208, respectively, which are encoded representations of the data, structure, and other characteristics of social network maps 201, 202, 203. Social network 200 may include one or more additional social network maps (not depicted), which, e.g., may be maintained, modified, etc. for different purposes, categories, etc., such as business, personal, family, friends, etc. and which each may include a corresponding design code (not depicted).

Social network maps 201, 202, 203 include a topology of social contact data represented by various nodes. For example, social network map 201 includes social contact data of a user 212 and of the contacts 213, 214, 215, 216 of the user. Similarly, social network map 202 includes social contact data of a modification contact 220 and the contacts 221, 222 of the modification contact 220. Social network map 203 includes a combination of social network map 201 and social network map 202 via a binding point 226. As indicated, there may be numerous other contacts included in social network maps 201, 202, 203 (that are not depicted). As described below, social network map 202 may, e.g., be inserted to social network 201 or deleted from social network 203 at binding point 226.

Design codes 206, 207, 208 are multi-dimensional bar code-like graphics that can encode various forms of data, such as the social contact data of social network maps 201, 202, 203. For example, QR Code® and Semacode® are two-dimensional configurations of design codes 206, 207, 208. Design codes 206, 207, 208 may include other multi-dimensional matrix codes, data matrix codes, paper memory (“PM”) codes, etc. Computing devices (such computing device 102) can be configured to generate, read, and/or otherwise interact with design codes (such as design codes 206, 207, 208), e.g., by executing appropriately configured software (e.g., software 110) and utilizing an appropriate input/output device (e.g., a scanner, cell phone camera, printer, etc.). Variations of design codes (e.g., varying by design, structure, dimensions, etc.) are under development, which, e.g., may be capable of encoding increasingly larger amounts and/or differing types of data. As discussed above, social network 200 may include one or more additional social network maps, which may be encoded in respective additional design codes (not depicted). Some exemplary interactions of computing devices and design codes will be described below.

Binding point 226 may be any point or location in the topology of social network map 201, 202, 203 (e.g., that depicted in FIG. 2). For example, binding point 226 may be at or between one of the social contact data nodes 212, 213, 214, 215, 216, 220, 221, 222. If social network 200 includes one or more additional social network maps, as discussed above, one or more of these additional social network maps may also include binding point 226.

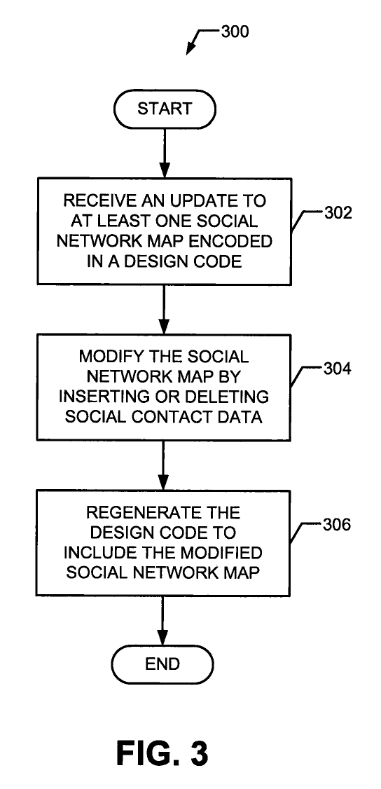

FIG. 3 illustrates an example of a method 300 to modify social networks via design codes, which is executable, for example, on the exemplary computing device 102 of FIG. 1 (e.g., as a computer program product). Exemplary method 300 may also describe an exemplary modification of social network 200 via design codes 206, 207, 208, e.g., by exemplary computing device 102. In block 302, an update to at least one social network map encoded in a design code is received. The social network map (e.g., social network map 201) represents a social network (e.g., social network 200) and includes a topology of social contact data (e.g., social contact data 212, 213, 214, 215, 216) encoded in a design code (e.g., design code 206). The update is encoded in a second design code (e.g., design code 207) and includes a modification to the topology (e.g., social network map 202) and a binding point (e.g., binding point 226) in the topology for the modification. The modification includes an insertion or deletion of social contact data (e.g., social contact data 220, 221, 222). The binding point may be specified, e.g., by a user input or pre-configuration.

In block 304, the social network map is modified by inserting or deleting the social contact data at the binding point in the topology. If the social network includes one or more additional social network maps that also include the binding point, the additional social network map is also modified dependent on a modification application setting. For example, the modification application setting (e.g., from a user input or pre-configuration) may direct whether to apply the modification to the one or more additional networks that include the binding point. A further example is described below.

In block 306, the design code is regenerated (e.g., design code 208) to include the modified social network map (e.g., social network map 203). If one or more additional social network maps were also modified by inserting or deleting the social contact data, the corresponding design code to the additional social network map is regenerated to include the modified additional social network map.

The following are several exemplary scenarios based on method 300. In a first exemplary scenario, a user meets an acquaintance when they are seated next to each other on an airplane flight. It turns out that the user and the new acquaintance are both very enthusiastic about a famous singer. Furthermore, the acquaintance happens to be the famous singer's personal exercise trainer. Before the user and the acquaintance proceed to their separate destinations after the flight, the user scans the acquaintances' design code from a business card using a cell phone camera and allows it to “morph” (i.e., modify) the user's design code according to method 300 described above. When the user reviews the user's social network later, the user notices that the new acquaintances social contact data is connected to the user's social contact data (e.g., which was the binding point specified by the user) and, as a result, is also connected to the famous singer's social contact data via the acquaintances' social network, which was inserted during the morph. Therefore, the user can now take pride in being only two degrees of separation from the famous singer in the user's social network.

In a second exemplary scenario, a user is employed as an athletic trainer for a popular sports team. The user is also an avid member of a local hobby club. The user maintains separate social network maps for “work contacts” and “hobby club contacts”, which are encoded in separate design codes. On one occasion, the user notices a potential new member of the hobby club who also happens to work for the sports team. The user wants to add the prospective new club-member and co-worker (“new contact”) to just the user's work contacts social network map, since this new contact is not yet a regularly participating member of the hobby club. Using a computing device (e.g., a cell phone or laptop computer), the user obtains the new contact's social contact data via a design code provided by the new contact (e.g., via another computing device using an infra-red connection, email, etc.) and specifies a binding point for the insertion of the new contact's social contact data in the user's social network. The binding point happens to exist in both the user's work contacts social network map and the user's hobby club contacts social network map, therefore the new contact's social contact data is inserted in just the work contacts social network map based on the user's preference (e.g., based on a pre-configured setting or an input, e.g., in response to a prompt).

In a third exemplary scenario, a first user has a group of friends that the first user regularly socializes with, and the first user has included the friends' social contact data in the first user's social network, which is encoded in a first design code. The first user becomes a close friend with a second user, who maintains a social network of the second user's other close friends that is encoded in a second design code. The first user and second user decide to import each other's social network into their own and do so by scanning the respective design codes via their cell phones. The first user's social network is modified by software on the first user's cell phone to insert the second user's social network at the selected binding point of the first user's social contact data node. Similarly, the second user's social network is modified by software on the second user's cell phone to insert the first user's social network at the selected binding point of the second user's social contact data node. The modified social networks are encoded respectively into the design codes of the first user and the second user by their cell phones, which can be used for future modifications with other users. As a result, the modified social network of the first user and the second user have the same topology except for the location of the users' social contact data node and, therefore, the design codes also have nearly the same appearance.

Exemplary system 100, computing device 102, and social network 200 are illustrated and described with respect to various components, modules, etc. for exemplary purposes. It should be understood that other variations, combinations, or integrations of such elements that provide the same features, functions, etc. are included within the scope of embodiments of the invention.

The flowchart and/or block diagram(s) in the Figure(s) described herein illustrate the architecture, functionality, and/or operation of possible implementations of systems, methods, and/or computer program products according to various embodiments of the present invention. In this regard, each block in a flowchart or block diagram may represent a module, segment, or portion of code, which comprises one or more executable instructions for implementing the specified logical function(s). It should also be noted that, in some alternative implementations, the functions noted in a flowchart or block diagram may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in a flowchart or block diagram can be implemented by special purpose hardware-based systems that perform the specified functions or acts, or combinations of special purpose hardware and computer instructions.

The terminology used herein is for the purpose of describing exemplary embodiments and is not intended to be limiting of the present invention. As used herein, the singular forms “a”, “an”, and “the” are intended to include the plural forms as well, unless the context clearly indicates otherwise. It will be further understood that the terms “comprises”, “comprising”, “includes”, or “including” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The exemplary embodiment(s) were chosen and described in order to explain the principles of the present invention and the practical application, and to enable others of ordinary skill in the art to understand the present invention for various embodiments with various modifications as are suited to the particular use contemplated.

As will be appreciated by one skilled in the art, the present invention may be embodied as a system, method, and/or computer program product. Accordingly, the present invention may take the form of an entirely hardware embodiment, an entirely software embodiment (including firmware, resident software, micro-code, etc.), and/or or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart and/or block diagram blocks.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

1. A method, comprising:
receiving an update to at least one social network map that represents a social network, wherein:
the social network map comprises a topology of social contact data encoded in a design code; and
the update is encoded in a second design code and comprises a modification to the topology and a binding point in the topology for the modification, wherein the modification comprises an insertion or deletion of the social contact data;
modifying the social network map by inserting or deleting the social contact data at the binding point in the topology, wherein at least one additional social network map is also modified by inserting or deleting the social contact data, dependent on a modification application setting, if the additional social network map includes the binding point; and
regenerating the design code to include the social network map modified, wherein an additional design code corresponding to the additional social network map is regenerated to include the additional social network map if the additional social network map was modified by inserting or deleting the social contact data;
presenting the social network map modified including the social contact data to a user on a display.
